(19) United States
(12) Patent Application Publication
(10) Pub. No.: US 2015/0174571 A1
(43) Pub. Date: Jun. 25, 2015

(54) HELICAL EXTRUSION OF UNSYMMETRICAL MULTI-LOBED CATALYST SUPPORTS

(71) Applicant: IFP Energies Nouvelles, Rueil-Malmaison Cedex (FR)

(72) Inventors: Frederic BAZER-BACHI, Irigny (FR); Yacine HAROUN, Grigny (FR); Mathieu DIGNE, Lyon (FR); Vincent LE CORRE, Saint-Just-Chaleyssin (FR)

(73) Assignee: IFP ENERGIES NOUVELLES, Rueil-Malmaison Cedex (FR)

(21) Appl. No.: 14/569,996

(22) Filed: Dec. 15, 2014

(30) Foreign Application Priority Data
Dec. 19, 2013 (FR) 13/63010

(51) Int. Cl. B01J 37/00; C10G 45/08; B01J 20/28; B01J 20/30; B01J 35/02

(52) U.S. Cl. CPC B01J 37/0009; B01J 20/3007; B01J 35/023; B01J 20/28014; C10G 45/08

(57) ABSTRACT

The invention relates to a catalyst support with an unsymmetrical multi-lobed cross-section in the shape of a helical extrudate having a rotational pitch comprised between 10 and 180° per mm.

The invention also relates to a catalyst, a recovery mass or an adsorbent comprising said support.

The invention also relates to the process for the preparation of said catalyst support in the shape of helical extrudates.

### FIELD OF THE INVENTION

The invention relates to the field of the preparation of catalyst supports by extrusion.

### TECHNOLOGICAL BACKGROUND

Catalyst supports prepared by extrusion have been the subject of numerous publications.

Numerous patents have thus been filed with the objective of protecting shapes of catalyst supports, generally a two-dimensional cross-section extruded axially over its entire length. For example, the patent CN 1045400C describes an unsymmetrical four-lobed shape belonging to the shapes referred to as “butterfly wings”.

Among the claimed advantages of these novel shapes, mention may be made in particular of the gain in catalytic efficiency, a smaller pressure drop in the catalytic bed, a lower loading density, and potentially also an improvement in mechanical strength.

The shapes filed are generally two-dimensional shapes, with axial symmetry of the extrudate.

It is sometimes envisaged to carry out a rotation of the shape, with several potential advantages: the increase in the surface-to-volume ratio allows, for example, better diffusion, and better catalytic efficiency. Moreover, there is a reduction in the loading density, and also in the pressure drop in the catalytic bed.

U.S. Pat. No. 4,673,664 describes for example helical extrudates of three-lobed or four-lobed cross-section. The advantages described in the document, for symmetrical multi-lobed shapes, relate mainly to the potential gain in pressure drop.

Patent Application WO12084788 moreover describes a process for the helical extrusion of particles having multi-lobed cross-sectional shapes, three-lobes or multi-lobes.

U.S. Pat. No. 4,673,664 however stresses problems of mechanical strength, in particular in terms of crushing strength, linked to the helical extrusion of compounds having a multi-lobed cross-section, compared with an axial extrusion.

Surprisingly, the applicant discovered that, on the contrary, the helical extrusion of asymmetrical multi-lobed shapes, in particular four-lobed, with a controlled rotational pitch, made it possible to solve the problems of mechanical strength raised in the prior art whilst obtaining significant specific surface areas and improved catalytic activities.

In fact, compared with the symmetrical shapes, the unsymmetrical shapes have very localized weak spots in terms of mechanical strength (FIGS. 1A and 1B). The crushing strength can in particular be characterized by the individual particle crushing strength (IPCS) technique.

A rotation of the multi-lobed shape according to height by helical extrusion results in the lateral displacement of the weak spots of the support around the catalyst (FIGS. 2A and 3A to be compared with FIGS. 2B and 3B respectively). FIG. 3B shows an example of an unsymmetrical four-lobed shape with a helical extrusion. When a helical support grain is subjected to a weight on one of its sides, it thus becomes possible to ensure that this weight does not only touch the weak spot of the cross-section throughout the height, therefore with a high risk of breakage, but that this weight touches a weak part and a strong part of the extrudate alternately (FIG. 1B and 3B). An overall better mechanical strength of the extrudates is thus obtained, which makes it possible in particular to bring the mechanical strength of a helical catalyst close to that of a straight catalyst.

In this way the applicant discovered that, besides solving the mechanical problems of the prior art, the helical extrusion, with a controlled rotational pitch, of a catalyst support the cross-section of which is multi-lobed, preferably four-lobed, and unsymmetrical gave rise to unexpected catalytic results.

### DESCRIPTION OF THE INVENTION

### Summary of the Invention

The invention relates to a catalyst support with an unsymmetrical multi-lobed cross-section in the shape of a helical extrudate having a rotational pitch comprised between 10 and 180° per mm, inclusive.

Preferably, the rotational pitch is comprised between 20 and 135° per mm, inclusive.

In an embodiment, the ratio of the length of the extrudate L to the equivalent diameter of said extrudate D is greater than or equal to 2 (L/D>=2) and the rotational pitch is comprised between 20 and 90°/mm, inclusive.

In another embodiment, the ratio of the length of the extrudate L to the equivalent diameter of said extrudate D is less than or equal to 2 (L/D<=2) and the rotational pitch is comprised between 60 and 135°/mm, inclusive.

Preferably, the cross-section is four-lobed.

The invention also relates to a catalyst comprising a support as described previously.

Said catalyst can comprise an active phase impregnated into said support.

The invention also relates to the use of said support as a recovery material.

The invention also relates to the use of said support as an adsorbent.

The invention finally relates to a process for the preparation of a catalyst support in the shape of helical extrudates as described above comprising:
a) preparing a paste for extrusion;
b) feeding the paste into an extruder with a rotating unsymmetrical multi-lobed die adjusted with a rotational pitch such that the rotational pitch obtained is from 10 to 180° per mm or feeding the paste into an extruder with a helical unsymmetrical multi-lobed die having a rotational pitch such that the rotational pitch obtained is from 10 to 180° per mm;
c) extruding helical extrudates of catalyst support.

### BRIEF DESCRIPTION OF THE DRAWINGS

FIGS. 1 to 8 are presented by way of illustration, and do not limit the scope of the invention in any way.

FIG. 1A—shows an example of modelling of the stress resistance distribution for two-dimensional shapes: for a conventional symmetrical three-lobed shape. The area indicated by an arrow in the figure corresponds to an area of higher stress.

FIG. 1B—shows an example of modelling of the stress resistance distribution for two-dimensional shapes: for an unsymmetrical four-lobed shape. The areas indicated by an arrow in the figure correspond to the areas of higher stress.

FIG. 2A—shows an axial or straight extrudate with a symmetrical four-lobed cross-section.

FIG. 2B—shows a helical extrudate with a symmetrical four-lobed cross-section.

FIG. 3A—shows an axial or straight extrudate with an unsymmetrical four-lobed cross-section.

FIG. 3B—shows a helical extrudate with an unsymmetrical four-lobed cross-section.

FIG. 4—shows the geometry of an extrudate cross-section with an unsymmetrical four-lobed shape, referred to as butterfly wings. R1 and S1 represent respectively the radius and the area of the two large lobes. R2 and S2 represent respectively the radius and the area of the two small lobes. R3, R4 and R5 are the radii of curvature of the connecting arcs between the lobes. L1, L2 and L3 are the characteristic lengths of the extrudate cross-section.

FIG. 5—shows the geometry of an extrudate cross-section with a particular four-lobed shape, having two small lobes of identical radius, two large lobes of identical radius, the centres of the large lobes not being equidistant to the line joining the centres of the circles circumscribed by the small lobes, and characterized by:
its characteristic lengths: length 1=1.5 and width L=1;
the radius of the smallest two lobes (R=0.2);
the radius of the largest two lobes (R=0.3);
the radius of curvature of the connecting arcs between the lobes (R=0.1).

FIG. 6—shows the mesh pattern of a helical extrudate with an unsymmetrical four-lobed cross-section as defined in FIG. 5, in order to identify the areas of higher stresses by the finite element modelling technique.

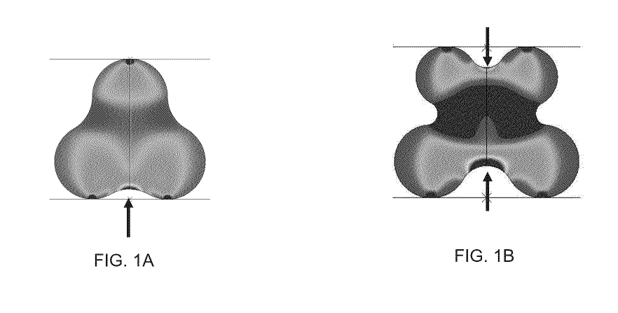

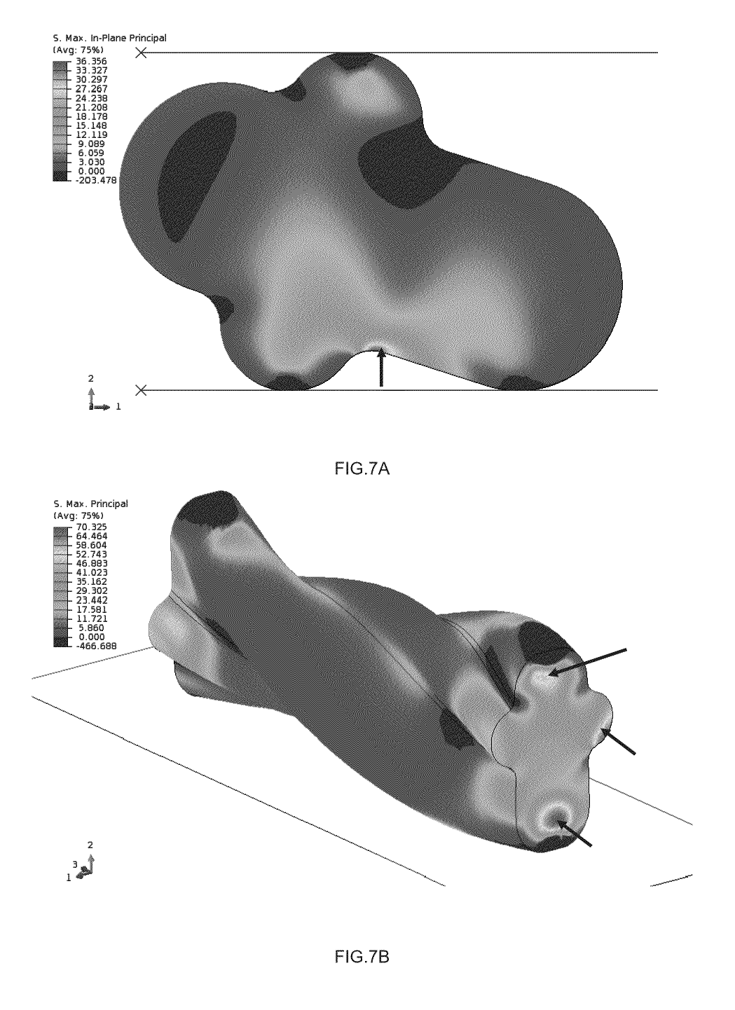

FIG. 7A—shows the crushing simulation results and the distribution of the stresses in the extrudate:
for an unsymmetrical four-lobed two-dimensional shape with a cross-section as defined in FIG. 5. The aresa indicated by an arrow correspond to the areas of higher stress Smax.

FIG. 7B—shows the crushing simulation results and the distribution of the stresses in the extrudate:
for a three-dimensional helical extrudate with a cross-section as defined in FIG. 5. The areas indicated by an arrow correspond to the areas of the highest stress Smax.

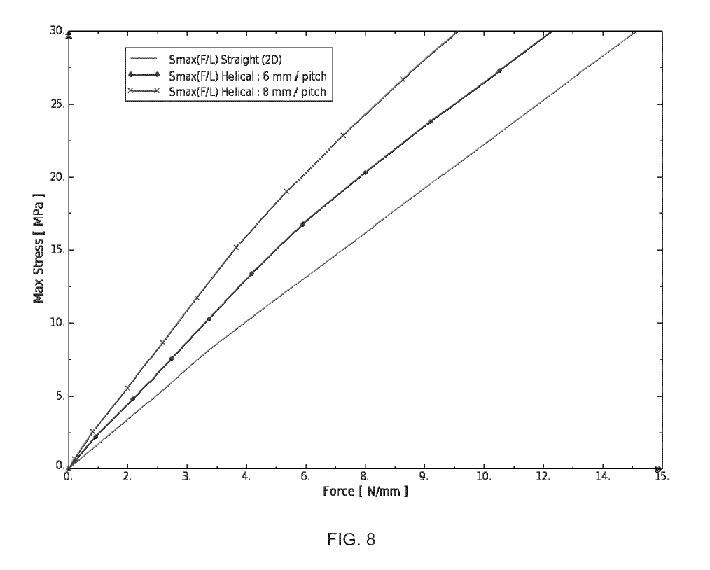

FIG. 8—represents the crushing strength results of three types of extrudates, namely the maximum tensile stress reached within the extrudate during a crushing test by the individual particle crushing strength (IPCS) technique. The graph shows the maximum stress (Max Stress in MPa) as a function of the force applied to the extrudate (Force in N/mm) for:
a straight extrudate (axial extrusion) with a cross-section as defined in FIG. 5
a helical extrudate (helical extrusion) with a cross-section as defined in FIG. 5 and having a rotational pitch of 60°/mm (6 mm for one complete rotation)
a helical extrudate (helical extrusion) with a cross-section as defined in

FIG. 5 and having a rotational pitch of 45°/mm (8 mm for one complete rotation).

### DETAILED DESCRIPTION OF THE INVENTION

The invention thus proposes implementing a controlled helical extrusion, for an unsymmetrical shape, the helical rotational pitch being selected as a function of the nature of the unsymmetrical shape, in particular the number of its lobes, and the number of its weak spots.

The extrudates thus obtained make it possible to solve the problems of mechanical strength raised in the prior art whilst maintaining an overall mechanical strength that is equivalent to, or at least not significantly lower than, that which would be obtained for straight shapes whilst obtaining unexpected catalytic properties.

Thus, surprisingly, outer surface assessments showed that the surface area of an unsymmetrical particle, defined as a shape having at least one lobe of a different size and subjected to a rotation, will increase relatively more than that of a symmetrical particle.

With an equivalent volume of grain, a greater outer surface area is thus developed.

### Shapes in Question

The invention relates to unsymmetrical multi-lobed shapes, i.e. multi-lobed cross-sections having at least one lobe greater than at least one other, advantageously defined as multi-lobed shapes in which at least one of the lobes has an area 10% greater than that of the smallest of the other lobes, preferably 20%, very preferably 30%, and even more preferably 40%. The area of a lobe is defined as the surface area of the ellipse circumscribed by the lobe.

The multi-lobed shapes can be three-lobed, preferably four-lobed.

Examples of unsymmetrical four-lobed shapes include in particular the “butterfly wings”-type shape with a cross-section as defined in FIG. 4 (“Butterfly”), or other unsymmetrical four-lobed shapes, for example with a cross-section as defined in FIG. 5.

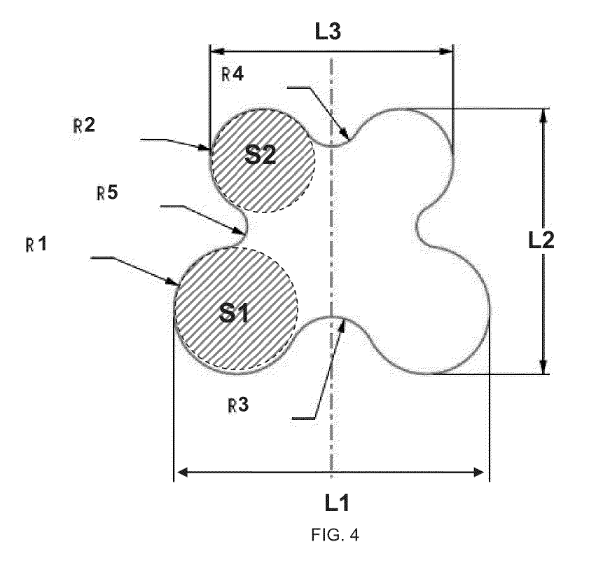

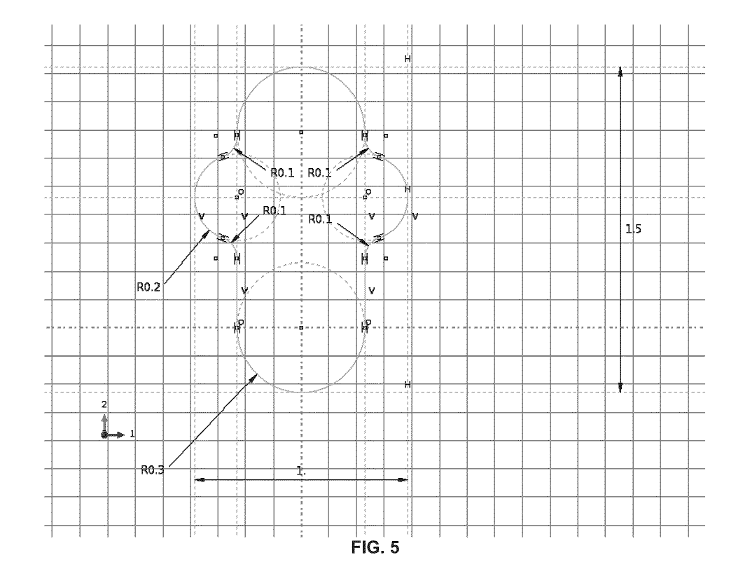

The relative increase in the surface area provided by the helical extrusion of unsymmetrical multi-lobed shapes is very significant (FIG. 3B).

### Helical Extrusion

The extruder is fed with the paste constituting the support to be extruded.

Said paste can be prepared by any method known to a person skilled in the art and can be obtained from one or more oxide powders (for example, alumina, silica, titanium, zirconia, or mixed oxides formed from these oxides), water, acid and/or mineral bases. Organic or mineral additives can be added to the formulation in order to facilitate the formation of the paste and its extrusion.

The paste can be obtained by any method known to a person skilled in the art and preferably by mixing. Different mixing tools can potentially be used and moving from mixing to extrusion can be discontinuous or continuous.

The extrusion is carried out helically, i.e. by rotating the extrusion die or using a die of helical shape.

According to the invention, the helical shape is controlled, in the sense that it depends on the number of weak spots of the shape. For example, it is possible, by modelling, to define the number of weak spots of the multi-lobed shape envisaged and their location, then to define a rotational pitch making it possible to reduce the impact of these weak spots on the overall mechanical strength of the extrudate.

Moreover, the selection of the rotational pitch can also be made as a function of the length L and the equivalent diameter D of the final extrudate envisaged, in particular as a function of the L/D ratio.

Finally, on the extrudate obtained, the rotational pitch of the shape results in a pitch comprised between 10°/mm and 180°/mm, preferably comprised between 20 and 135°/mm, even more preferably comprised between 20 and 90°/mm, the rotational pitch being the ratio of the angle of rotation of the cross-section to the length of the extrudate.

As a function of the length of the extrudate L and of its diameter D, it is also possible to optimize the rotational pitch: preferably, for L/D ratios greater than or equal to 2, a rotational pitch comprised between 20 and 90°/mm will be used, for L/D ratios less than or equal to 2, a rotational pitch comprised between 60 and 135°/mm will rather be used.

### Applications of the Supports According to the Invention

The support extrudates according to the invention can be used for preparing supported or bulk catalysts, or recovery masses, or adsorbents, in particular in the field of refining and petrochemicals. These extrudates can in particular be used in the reactions where there are diffusional limitations: FCC pre-treatment, HCK, hydrodemetallization, selective hydrogenations etc.

### EXAMPLES

### Example 1

### Gain in Surface Area Developed by Helical Extrusion of an Unsymmetrical Multi-Lobed Shape

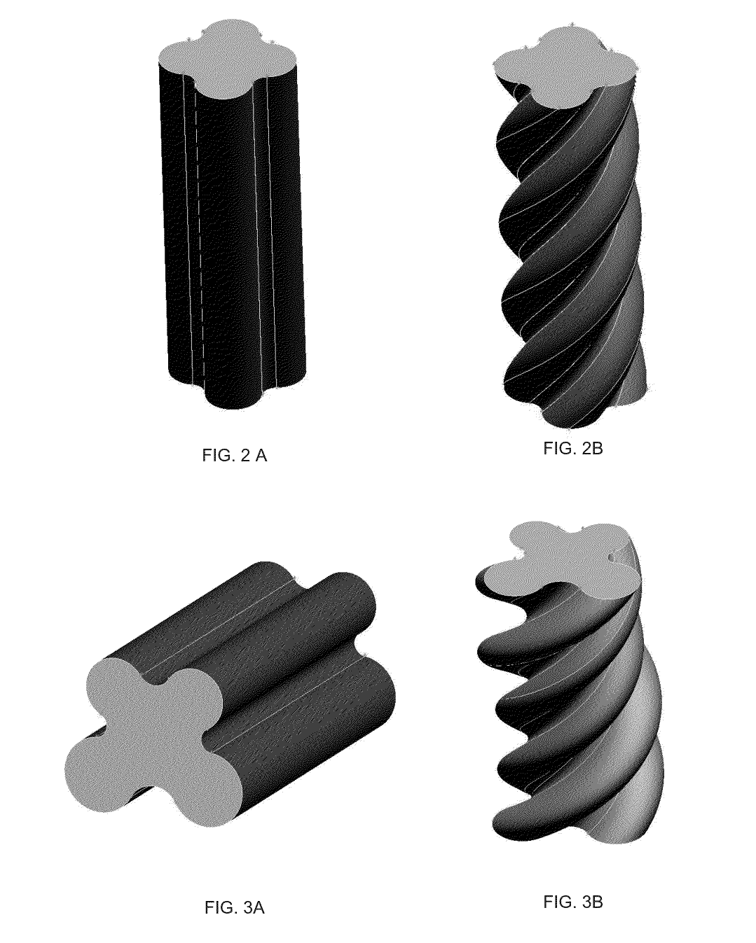

This example refers to FIGS. 2A and 2B (according to the prior art) and to FIGS. 3A and 3B (according to the invention).

By modelling, a rotation is applied to a shape with a four-lobed cross-section making it possible to simulate a helical extrusion with a symmetrical (FIGS. 2A and 2B) or unsymmetrical (FIGS. 3A and 3B) multi-lobed shape.

TABLE 1
Helical extrusion of a symmetrical multi-lobed shape

| | Symmetrical four-lobed shape | | |
|---|---|---|---|
| | (FIGS. 2A and 2B) | | |
| Rotation (°) | 0° | 360°/4 mm | Gain |
| V (m3) | 7.17E−09 | 7.17E−09 | |
| S (m2) | 2.53E−05 | 2.81E−05 | 11% |
| 6 V/S | 1.70E−03 | 1.529E−03 | |

TABLE 2
Helical extrusion of an unsymmetrical multi-lobed shape

| | Unsymmetrical four-lobed shape | | |
|---|---|---|---|
| | (FIGS. 3A and 3B) | | |
| Rotation (°) | 0° | 360°/4 mm | Gain |
| V (m3) | 1.01E−08 | 1.01E−08 | |
| S (m2) | 3.56E−05 | 4.46E−05 | 25.43% |
| 6 V/S | 1.70E−03 | 1.35E−03 | |

This example shows that the gain in developed surface area allowed by a helical rotation is greater for an unsymmetrical polylobed extrudate (+25.4%) than for a symmetrical polylobed extrudate (+11%), for the same rotational pitch and the same V/S ratio of the corresponding straight extrudate.

### Example 2

### Mechanical Properties of the Helical Extrudates

For a shape with an unsymmetrical four-lobed cross-section as shown in FIG. 5, three geometries of extrudates are compared by modelling: straight extrudate, 45°/mm helical extrudate (8 mm/pitch) and 60°/mm helical extrudate (6 mm/pitch).

The criterion for comparison is the maximum tensile stress reached within the extrudate during a crushing test (individual particle crushing strength (IPCS)).

For each calculation, the model is constituted by an elastic solid extrudate in contact with two rigid plates. One plate is fixed and the other, which is mobile, serves to apply the crushing force.

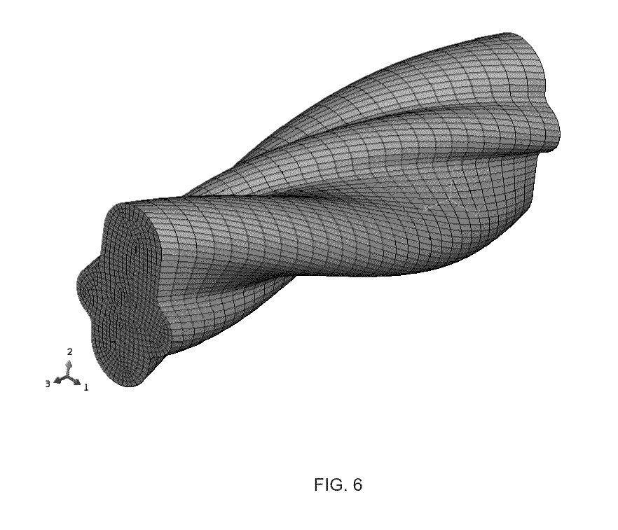

The calculations carried out are 2D and 3D numerical calculations by the finite element method (FEM) after mesh patterning of the two-dimensional shape or of the helical three-dimensional extrudate (FIG. 6).

The results of the modelling show that the position of the maximum stress is very different in the helical extrudates compared with the initial 2D shape (FIGS. 7 A and 7B).

Moreover, for a given breaking stress of 27 MPa, the results show (FIG. 8) that:
the force corresponding to the IPCS of the straight extrudate (Smax(F/L) Straight 2D) is 1.3 daN/mm.
the force corresponding to the IPCS of the 45°/mm helical extrudate (Smax(F/L) Helical 8 mm/pitch) is 0.85 daN/mm.
the force corresponding to the IPCS of the 60°/mm helical extrudate (Smax(F/L) Helical 6 mm/pitch) is 1.05 daN/mm.

Thus, the greater the rotation of the shape, the closer it gets to the strength of a straight extrudate.

Moreover, it appears that the strength of the helical extrudates is less sensitive to separation between the lobes.

Example 2 therefore shows that, unexpectedly, the mechanical strength of helical extrudates with an unsymmetrical polylobed cross-section is close to that of straight extrudates. In fact, although the crushing strength (characterized by the IPCS) is slightly less than that of the straight extrudates, the position of the maximum stress is very different, in terms of both position and intensity, in the helical extrudates. Statistically, the mechanical strength of the bed of extrudates is therefore improved and is virtually equivalent to that of a bed of straight extrudates.

### Example 3

### Catalytic Activity as Regards Conversion

An alumina-based support is prepared so as to be able to prepare catalysts with different shapes. In order to do this, a boehmite (or alumina gel) according to the process described in U.S. Pat. No. 4,154,812 is used. The reactor is heated to 65° C. Before the phase of simultaneous addition of the two reagents, approximately 8 g equivalent of Al₂O₃ is introduced into a volume of 1290 mL.

During the phase of simultaneous addition of the two reagents, the pH is maintained at a value close to 9. At the end of the addition, 144 g equivalent of Al₂O₃ is added for a total volume of 3530 mL. The boehmite in suspension thus obtained is filtered, washed so as to remove the impurities and dried overnight at 120° C. in order to obtain a gel. This gel is then mixed with an aqueous solution containing 52.7% nitric acid (1% by weight of acid per gram of dry gel), then mixed for 20 minutes in a mixer with Z-shaped arms, in order to obtain a paste. The paste is then mixed with an aqueous solution containing 20.3% ammonium hydroxide (40 mol.% of ammonia per mole of acid) for 5 minutes in the same mixer. At the end of this mixing, the paste obtained is divided into four batches: each batch is shaped on an extruder piston through a die having an opening of a defined geometry in order to obtain the desired shapes of extrudates. The extrudates are then dried overnight at 120° C., then calcined at 700° C. for two hours under a flow of moist air containing 200 g of water/kg of dry air.

In this way, extrudates of variable shape are obtained, having a specific surface area of 210 m²/g, a total pore volume of 0.80 ml/g, a mesopore distribution centred on 13 nm (Vmeso pd/2). This alumina also contains 0.20 ml/g of pore volume in the pores with a diameter greater than 50 nm (macropore volume), i.e. a macropore volume equal to 25% of the total pore volume.

The supports thus obtained are impregnated when dry as follows: the aqueous solution for impregnation contains molybdenum and nickel salts, as well as phosphoric acid (H₃PO₄) and hydrogen peroxide (H₂O₂). The molybdenum salt is ammonium heptamolybdate, Mo₇O₂₄(NH₄)₆.4H₂O, and the nickel salt is nickel nitrate, Ni(NO₃)₂.6H₂O. The quantities of each of these salts in solution are determined so as to deposit the desired quantity of each element in the catalyst.

After maturation at ambient temperature in an atmosphere saturated with water, the impregnated support extrudates are dried overnight at 120° C., then calcined at 500° C. for 2 hours under air. The molybdenum trioxide content is 6% by weight, the nickel oxide content is 1.5% by weight, and the phosphorus pentoxide content is 1.2% by weight. The P/Mo atomic ratio is equal to 0.4 and the Ni/Mo atomic ratio is equal to 0.49.

The dies used have only one hole: they are made of tungsten carbide. They are presented in the shape of a disc 3 cm in diameter and with a thickness of approximately 4 mm in the central part. The hole is cut out by machining in the centre of the die so as to have the shape and the diameter of the desired extrudate.

A rotation is applied to the die, according to the rotational pitch envisaged on the final extrudate.

Four catalysts were produced:
C1 (comparative): a symmetrical four-lobed catalyst with a 1.8 mm die, with a length of 4 mm, extruded axially;
C2 (comparative): an unsymmetrical four-lobed “butterfly wings” catalyst with a die diameter of 2.5 mm, length of 4 mm, (the size of the die for the “butterfly wings” four-lobed shape was adjusted in order to have a volume/surface V/S ratio equivalent to the symmetrical four-lobed shape), with a section as shown in FIG. 4, extruded axially, the geometric characteristics of which are as follows:

| R1/R2 | R1/R3 | R1/R4 | R1/R5 | L1/L2 |
|---|---|---|---|---|
| 1.20 | 1.43 | 2.14 | 3.00 | 1.20 |

C3 (comparative): a helical symmetrical four-lobed catalyst, of the same size as the axially symmetrical reference, extruded helically with a rotational pitch of 90°/mm;
C4 (according to the invention): a helical unsymmetrical four-lobed “butterfly wings” catalyst, with a die diameter of 2.5 mm and with the same length of 4 mm (the size of the die of the four-lobed “butterfly wings” shape was adjusted in order to have a V/S equivalent to the symmetrical four-lobed shape, and therefore a priori the same catalytic activity), with a cross-section as shown in FIG. 4, extruded helically, with a rotational pitch of 90°/mm.

The catalysts C1 to C4 were impregnated with an active phase of CoMoNiP with 6% MoO3.

The void fractions are equivalent during the four fillings (approximately 41%), therefore the loading density is the same.

The tests were carried out in a laboratory reactor. The reactor is a fixed-bed reactor for the pre-treatment of a mixture of atmospheric residue (AR) and vacuum residue (VR), at 50/50% by mass.

The temperature is 390° C., the pressure 180 bar.

The ratio of the height to the diameter of the reactor H/D is equal to 3.

The WHSV (mass flow rate per mass of catalyst) is 1.4 ⁻¹.

The experiments showed:
similar hydrodemetallization HDM conversions for the two non-helical catalysts C1 and C2: 79.4 and 79.2% respectively for the symmetrical four-lobed shape and the unsymmetrical “butterfly wings” four-lobed shape;
a hydrodemetallization HDM conversion of 81.7% for the helical symmetrical four-lobed shape C3;
a hydrodemetallization HDM conversion of 84.1% for the helical “butterfly wings” unsymmetrical four-lobed shape C4 (according to the invention).

The unexpected conversion results obtained for the catalyst according to the invention show the benefit of carrying out a controlled rotation for an unsymmetrical shape: without wishing to be bound by any theory, it would appear that the relative conversion gain is linked, at least in part, to the greater relative increase in the outer surface area.

TABLE 3
Catalytic conversion data and results for the catalysts C1 to C4

| | | Unsymmetrical four- | | | |
|---|---|---|---|---|---|
| | | lobed cross-section | | | |
| | | | Helical | Symmetrical four- | |
| | | | C4 | lobed cross-section | |
| | | Axial | (according | Axial | Helical |
| | | C2 | to the | C1 | C3 |
| | | (comp.) | invention) | (comp.) | (comp.) |
| Volume (V) | (m3) | 1.01E−08 | 1.01E−08 | 7.17E−09 | 7.16E−09 |
| Surface (S) | (m2) | 3.56E−05 | 4.46E−05 | 2.53E−05 | 2.81E−05 |
| 6 V/S | (m) | 1.70E−03 | 1.36E−03 | 1.70E−03 | 1.53E−03 |
| WHSV | (1/h) | 1.41 | 1.41 | 1.41 | 1.41 |
| Conversion (X) | (—) | 79.26% | 84.10% | 79.29% | 81.72% |

Examples 1 to 3 show the benefit of utilizing helical extrudates having an unsymmetrical multi-lobed cross-section. Improved catalytic activity is thus obtained, whilst maintaining a mechanical strength that is completely satisfactory compared with straight extrudates.

Without further elaboration, it is believed that one skilled in the art can, using the preceding description, utilize the present invention to its fullest extent. The preceding preferred specific embodiments are, therefore, to be construed as merely illustrative, and not limitative of the remainder of the disclosure in any way whatsoever.

The preceding examples can be repeated with similar success by substituting the generically or specifically described reactants and/or operating conditions of this invention for those used in the preceding examples.

From the foregoing description, one skilled in the art can easily ascertain the essential characteristics of this invention and, without departing from the spirit and scope thereof, can make various changes and modifications of the invention to adapt it to various usages and conditions.

The entire disclosures of all applications, patents and publications, cited herein and of corresponding French Application No. 13/63010, filed Dec. 19, 2013 are incorporated by reference herein.

1. Catalyst support with an unsymmetrical multi-lobed cross-section in the shape of a helical extrudate having a rotational pitch comprised between 10 and 180° per mm, inclusive.

2. Catalyst support according to claim 1 in which the rotational pitch is comprised between 20 and 135° per mm, inclusive.

3. Catalyst support according to claim 1 in which the ratio between the length of the extrudate L and the equivalent diameter of said extrudate D is greater than or equal to 2 (L/D>=2) and the rotational pitch is comprised between 20 and 90°/mm, inclusive.

4. Catalyst support according to claim 1 in which the ratio between the length of the extrudate L and the equivalent diameter of said extrudate D is less than or equal to 2 (L/D<=2) and the rotational pitch is comprised between 60 and 135°/mm, inclusive.

5. Catalyst support according to claim 1 in which the cross-section is four-lobed.

6. Catalyst comprising a support according to claim 1.

7. Catalyst according to claim 6 comprising an active phase impregnated into said support.

8. A method comprising using the support according to claim 1 as a recovery material.

9. A method comprising using the support according to claim 1 as an adsorbent.

10. Process for the preparation of a catalyst support in the shape of helical extrudates according to claim 1 comprising:
a) preparing a paste for the extrusion;
b) feeding the paste into an extruder with a rotating unsymmetrical multi-lobed die adjusted with a rotational pitch such that the rotational pitch obtained is from 10 to 180° per mm, or feeding the paste into an extruder with a helical unsymmetrical multi-lobed die having a rotational pitch such that the rotational pitch obtained is from 10 to 180° per mm;
c) extruding helical extrudates of catalyst support.
